(19) United States
(12) Patent Application Publication
(10) Pub. No.: US 2020/0399923 A1
(43) Pub. Date: Dec. 24, 2020

(54) POLE MOUNTING APPARATUS AND METHOD OF USING SAME

(71) Applicant: Jared Paul Sanger, Grand Forks, ND (US)

(72) Inventor: Jared Paul Sanger, Grand Forks, ND (US)

(21) Appl. No.: 16/946,400

(22) Filed: Jun. 19, 2020

Related U.S. Application Data
(60) Provisional application No. 62/863,741, filed on Jun. 19, 2019.

(51) Int. Cl. E04H 12/22; G09F 17/00

(52) U.S. Cl. CPC E04H 12/2269; G09F 17/00

(57) ABSTRACT

In an embodiment, a method for mounting a pole on a post includes providing an apparatus having an inner portion, an outer portion and a cap portion. The inner portion has a substantially cylindrical shape and includes open first and second ends; the outer portion has a substantially cylindrical shape with a diameter that is greater than a diameter of the inner portion and includes open first and second ends; and the cap portion has first and second ends and has a substantially circular shape with an outer diameter that is substantially similar to the diameter of the outer portion and has a substantially circular aperture with a diameter that is substantially similar to a diameter of the open first end of the inner portion. The first ends of the inner portion and the outer portion may be connected to the second end of the cap portion.

### RELATED APPLICATION

This application claims priority to U.S. provisional patent application No. 62/863,741, filed on Jun. 19, 2019 and entitled POLE MOUNTING APPARATUS AND METHOD OF USING SAME, and which is incorporated herein by reference in its entirety.

### FIELD OF THE INVENTION

The present invention in general relates to the field of support structures for mounting and supporting poles.

### BACKGROUND OF THE INVENTION

There is no admission that the background art disclosed in this section legally constitutes prior art.

Posts are often installed on docks for boats to be used to secure a boat to the post with a rope. Dock posts may also be used to support other structures such as poles that could be inserted into a hollow middle portion of the post. For example, a flagpole may be inserted into the dock post. However, a problem arises if the flag is not attached securely to the post. This may be especially true when the weather is windy causing the flag and pole to rotate in an uncontrolled fashion, or even worse, disengage from the dock post.

Therefore, there is a need for a structure that can support and secure a pole such as a flagpole to a post on a boat dock.

### BRIEF DESCRIPTION OF THE DRAWINGS

In order to better understand the invention and to see how the same may be carried out in practice, non-limiting preferred embodiments of the invention will now be described with reference to the accompanying drawings, in which:

FIG. 1 is a side perspective view of a pole mounting apparatus, which is constructed in accordance with an embodiment;

FIG. 2 is a cross-sectional view of the pole mounting apparatus of FIG. 1, which is constructed in accordance with an embodiment;

FIG. 3 is a cross-sectional view of the pole mounting apparatus of FIG. 1, which is constructed in accordance with an embodiment;

FIG. 4 is a cross-sectional view of the pole mounting apparatus of FIG. 1, which is constructed in accordance with an embodiment;

FIG. 5 is a side perspective view of a pole mounting apparatus, which is constructed in accordance with another embodiment;

FIG. 6 is a cross-sectional view of the pole mounting apparatus of FIG. 5, which is constructed in accordance with an embodiment;

FIG. 7 is a cross-sectional view of the pole mounting apparatus of FIG. 5, which is constructed in accordance with an embodiment;

FIG. 8 is a cross-sectional view of the pole mounting apparatus of FIG. 5, which is constructed in accordance with an embodiment;

FIGS. 9A-D are perspective views of the pole mounting apparatus of FIG. 1 being used in accordance with an embodiment; and

FIG. 10 is a cross-sectional view of the pole mounting apparatus of FIG. 1 being used in accordance with an embodiment.

### DETAILED DESCRIPTION OF CERTAIN EMBODIMENTS OF THE INVENTION

Certain embodiments of the present invention will now be described more fully hereinafter with reference to the accompanying drawings, in which some, but not all, embodiments of the invention are shown. Indeed, these embodiments of the invention may be in many different forms and thus the invention should not be construed as limited to the embodiments set forth herein; rather, these embodiments are provided as illustrative examples only so that this disclosure will satisfy applicable legal requirements. Like numbers refer to like elements throughout.

It will be readily understood that the components of the embodiments as generally described and illustrated in the drawings herein, could be arranged and designed in a wide variety of different configurations. Thus, the following more detailed description of the certain ones of the embodiments of the system, components and method of the present invention, as represented in the drawings, is not intended to limit the scope of the invention, as claimed, but is merely representative of the embodiment of the invention.

An embodiment of the invention provides an apparatus and a method of using same for supporting and securing a pole, such as a flagpole, to a post on a boat dock. In an embodiment, the apparatus for mounting a pole includes an inner portion having a substantially cylindrical shape and including open first and second ends; an outer portion having a substantially cylindrical shape with a diameter that is greater than a diameter of the inner portion and including open first and second ends; and a cap portion having first and second ends and having a substantially circular shape with an outer diameter that is substantially similar to the diameter of the outer portion and having a substantially circular aperture with a diameter that is substantially similar to a diameter of the open first end of the inner portion. The first end of the inner portion and the first end of the outer portion may be connected to the second end of the cap portion.

In an embodiment, the open lower end of the inner portion may include a chamfer-shaped edge and the open lower end of the outer portion may include a chamfer-shaped edge. In a further embodiment, the inner portion may include one or more holes disposed below the outer portion for insertion of one or more fasteners to selectably and securely engage the inner portion to the pole. In another embodiment, the outer portion may include one or more holes for insertion of one or more fasteners to selectably and securely engage the outer portion to a post. In an embodiment, the post may be a boat dock post.

In an embodiment, a method for mounting a pole on a post includes providing an apparatus having an inner portion, an outer portion and a cap portion. The inner portion has a substantially cylindrical shape and includes open first and second ends; the outer portion has a substantially cylindrical shape with a diameter that is greater than a diameter of the inner portion and includes open first and second ends; and the cap portion has first and second ends and has a substantially circular shape with an outer diameter that is substantially similar to the diameter of the outer portion and has a substantially circular aperture with a diameter that is substantially similar to a diameter of the open first end of the inner portion. The first end of the inner portion and the first end of the outer portion may be connected to the second end of the cap portion.

The method also includes the steps of inserting the pole via the circular aperture of the cap portion through the first end and the second end of the inner portion of the apparatus; fastening the apparatus to the pole; inserting the inner portion of the apparatus into the post until the post is adjacent to the second end of the cap portion; and fastening the apparatus to the post.

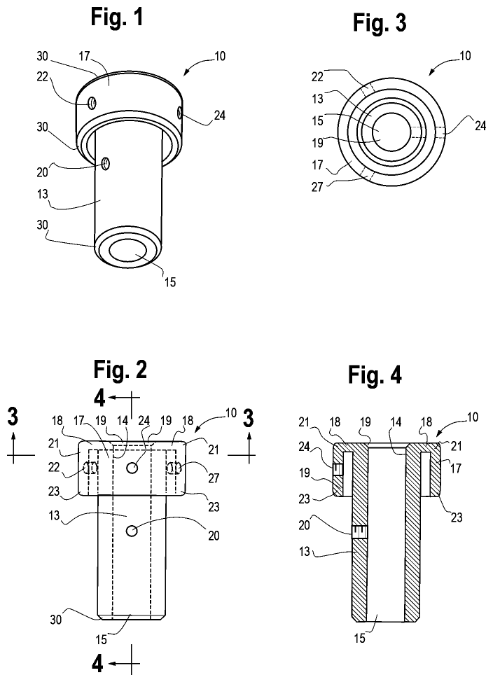

Referring now to the drawings, and more particularly to FIGS. 1-4 thereof, an apparatus generally indicated at 10 enables a pole to be mounted and supported on a post, such as a boat dock post, which may be constructed according to an embodiment. In an embodiment, the apparatus 10 may include an inner portion 13 having a substantially cylindrical shape, and having an open upper (first) end 14 and an open lower (second) end 15. The apparatus 10 may also include an outer portion 17 having a substantially cylindrical shape with a diameter that is greater than a diameter of the inner portion 13, and having an open upper (first) end 21 and an open lower (second) end 23. The apparatus 10 may also include a cap portion 18 having a substantially circular shape having an outer diameter that is substantially similar to the diameter of the outer portion 17. The cap portion 18 may also include a substantially circular aperture 19 having a diameter that is substantially similar to the diameter of the open upper end 14 of the inner portion 13. The upper end 14 of the inner portion 13 and the upper end 21 of the outer portion 17 are connected to a bottom portion of the cap portion 18. In an embodiment, the open lower end 15 of the inner portion 13 and the open lower end 23 of the outer portion 17 may include chamfer-shaped edges 30.

The inner portion 13 may include one or more apertures or holes, such as fastener hole 20, disposed below and not contained by the outer portion 17. Hole 20 is provided for insertion of a fastener, such as a screw, to selectably and securely engage a cylindrical pole, such as a flagpole, to the inner portion 13 of the apparatus 10. The outer portion 17 may include one or more apertures or holes, such as fastener holes 22, 24 and 27 to selectably and securely engage a cylindrical post, such as a boat dock post, to the outer portion 17 of the apparatus 10. While the pole and the post may be substantially cylindrical in shape, the apparatus 10 is designed to engage poles and posts that may comprise other shapes such as square, rectangular, triangular, oblong, and other.

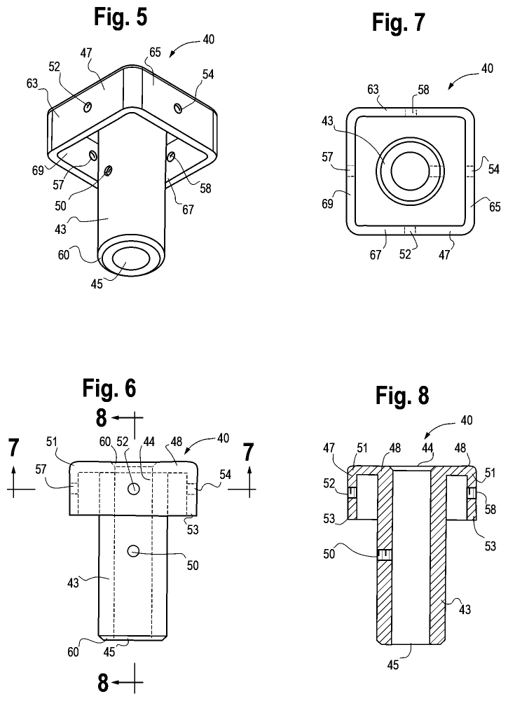

Referring now to FIGS. 5-8 thereof, an apparatus generally indicated at 40 enables a pole to be mounted and supported on a post such as a boat dock post, which may be constructed according to another embodiment. In an embodiment, the apparatus 40 may include an inner portion 43 having a substantially cylindrical shape, and having an open upper (first) end 44 and an open lower (second) end 45. The apparatus 40 may also include an outer portion 47 having four outer sides 63, 65, 67 and 69 that may comprise a substantially square shape with a diameter that is greater than a diameter of the inner portion 43, and having an open upper (first) end 51 and an open lower (second) end 53. The apparatus 40 may also include a cap portion 48 having a four sided or substantially square shape having an outer diameter that is substantially similar to the diameter of the outer portion 47. The cap portion 48 may also include a substantially circular aperture 49 having a diameter that is substantially similar to the diameter of the open upper end 44 of the inner portion 43. The upper end 44 of the inner portion 43 and the upper end 51 of the outer portion 47 are connected to a bottom portion of the cap portion 48. In an embodiment, the open lower end 45 of the inner portion 43 and the open lower end 53 of the outer portion 47 may include chamfer-shaped edges 60.

The inner portion 43 may include one or more apertures or holes, such as fastener hole 50, formed below and not contained by the outer portion 47. Hole 50 is provided for insertion of a fastener, such as a screw, to selectably and securely engage a cylindrical pole, such as a flagpole, to the inner portion 43 of the apparatus 40. The outer portion 47 may include one or more apertures or holes, such as fastener holes 52, 54, 57 and 58 to selectably and securely engage a cylindrical post such as a boat dock post to the outer portion 47 of the apparatus 40. While the pole and the post may be substantially cylindrical in shape, the apparatus 40 is designed to engage poles and posts that may comprise other shapes such as square, rectangular, triangular, oblong, and other.

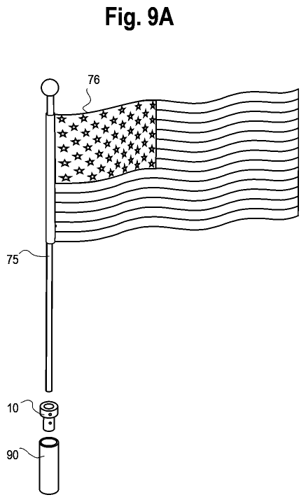

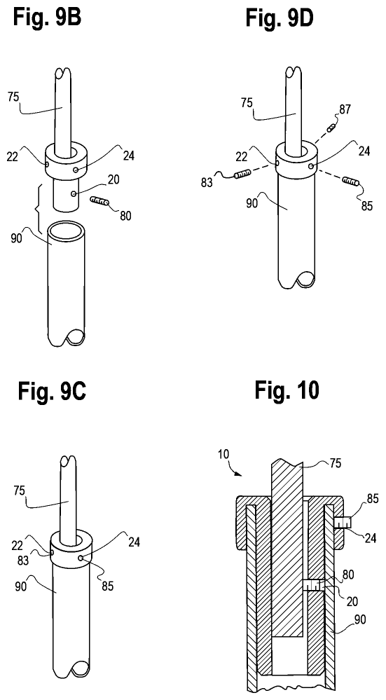

Referring now to FIGS. 9A-D and FIG. 10 thereof, a method is shown that enables a pole, such as a flag pole, to be mounted to an apparatus generally indicated at 40 and supported on a post, such as a boat dock post, which may be constructed according to another embodiment. In the method, one end of a flag pole 75 having a flag 76 attached thereto may be inserted via the circular aperture 19 of the cap portion 18 through the upper end 14 and the lower end 15 of the inner portion 13 of the apparatus 10. A fastener such as a screw 80 is inserted into hole 20 to selectably and securely engage the apparatus 10 to the flagpole 76.

After the flag pole 76 is secured to the apparatus 10, the inner portion 13 of the apparatus 10 may be inserted into a cylindrical post such as boat dock post 90 until the top of the dock post 90 is substantially adjacent to the underside of the cap portion 18. Then, one or more fasteners such as screws 83, 85 and 87 may be inserted through holes 22, 24 and 27 respectively to secure the apparatus 10 to the boat dock post 90. At this point, the flagpole 76 is securely held in position within the boat dock post 90 by the apparatus 10 as shown in FIG. 10.

In a similar fashion, the method may secure a flagpole to a boat dock post by employing the apparatus 40 as shown in FIGS. 5-8. In this method, one or more fasteners such as four screws (not shown) may be inserted into holes 52, 54, 57 and 58 to secure the apparatus 40 to the boat dock post.

Numerous embodiments are described in the present application, and are presented for illustrative purposes only. The described embodiments are not, and are not intended to be, limiting in any sense. The presently disclosed inventions are widely applicable to numerous embodiments, as is readily apparent from the disclosure. One of ordinary skill in the art will recognize that the disclosed inventions may be practiced with various modifications and alterations, such as structural, logical, software and electrical modifications. Although particular features of the disclosed inventions may be described with reference to one or more particular embodiments and/or drawings, it should be understood that such features are not limited to usage in the one or more particular embodiments or drawings with reference to which they are described, unless expressly specified otherwise.

Though an embodiment may be disclosed as including several features, other embodiments of the invention may include fewer than all such features. Thus, for example, a claim may be directed to less than the entire set of features in a disclosed embodiment, and such claim would not include features beyond those features that the claim expressly recites.

No embodiment of method steps or product elements described in the present application constitutes the invention claimed herein, or is essential to the invention claimed herein, or is coextensive with the invention claimed herein, except where it is either expressly stated to be so in this specification or expressly recited in a claim.

Although the invention has been described with reference to the above examples, it will be understood that many modifications and variations are contemplated within the true spirit and scope of the embodiments of the invention as disclosed herein. Many modifications and other embodiments of the invention set forth herein will come to mind to one skilled in the art to which the invention pertains having the benefit of the teachings presented in the foregoing descriptions and the associated drawings. Therefore, it is to be understood that the invention shall not be limited to the specific embodiments disclosed and that modifications and other embodiments are intended and contemplated to be included within the scope of the appended claims. Although specific terms are employed herein, they are used in a generic and descriptive sense only and not for purposes of limitation.

What is claimed is:

1. An apparatus for mounting a pole, comprising:
an inner portion having a substantially cylindrical shape and including open first and second ends;
an outer portion having a substantially cylindrical shape with a diameter that is greater than a diameter of the inner portion and including open first and second ends; and
a cap portion having first and second ends and having a substantially circular shape with an outer diameter that is substantially similar to the diameter of the outer portion and having a substantially circular aperture with a diameter that is substantially similar to a diameter of the open first end of the inner portion; and
wherein the first end of the inner portion and the first end of the outer portion are connected to the second end of the cap portion.

2. The apparatus of claim 1, wherein the open lower end of the inner portion further includes a chamfer-shaped edge.

3. The apparatus of claim 1, wherein the open lower end of the outer portion further includes a chamfer-shaped edge.

4. The apparatus of claim 1, wherein the inner portion further includes one or more holes disposed below the outer portion for insertion of one or more fasteners to selectably and securely engage the inner portion to the pole.

5. The apparatus of claim 1, wherein the outer portion further includes one or more holes for insertion of one or more fasteners to selectably and securely engage the outer portion to a post.

6. The apparatus of claim 5, wherein the post is a boat dock post.

7. An apparatus for mounting a pole, comprising:
an inner portion having a substantially cylindrical shape and including open first and second ends;
an outer portion having a substantially square shape with a diameter that is greater than a diameter of the inner portion and including open first and second ends; and
a cap portion having first and second ends and having a substantially square shape with an outer diameter that is substantially similar to the diameter of the outer portion and having a substantially circular aperture with a diameter that is substantially similar to a diameter of the open first end of the inner portion; and
wherein the first end of the inner portion and the first end of the outer portion are connected to the second end of the cap portion.

8. The apparatus of claim 1, wherein the open lower end of the inner portion further includes a chamfer-shaped edge.

9. The apparatus of claim 1, wherein the open lower end of the outer portion further includes a chamfer-shaped edge.

10. The apparatus of claim 1, wherein the inner portion further includes one or more holes disposed below the outer portion for insertion of one or more fasteners to selectably and securely engage the inner portion to the pole.

11. The apparatus of claim 1, wherein the outer portion further includes one or more holes for insertion of one or more fasteners to selectably and securely engage the outer portion to a post.

12. The apparatus of claim 5, wherein the post is a boat dock post.

13. A method for mounting a pole on a post, comprising:
providing an apparatus having an inner portion, an outer portion and a cap portion;
the inner portion having a substantially cylindrical shape and including open first and second ends; the outer portion having a substantially cylindrical shape with a diameter that is greater than a diameter of the inner portion and including open first and second ends; and the cap portion having first and second ends and having a substantially circular shape with an outer diameter that is substantially similar to the diameter of the outer portion and having a substantially circular aperture with a diameter that is substantially similar to a diameter of the open first end of the inner portion; and wherein the first end of the inner portion and the first end of the outer portion are connected to the second end of the cap portion;
inserting the pole via the circular aperture of the cap portion through the first end and the second end of the inner portion of the apparatus;
fastening the apparatus to the pole;
inserting the inner portion of the apparatus into the post until the post is substantially adjacent to the second end of the cap portion; and
fastening the apparatus to the post.

14. The method of claim 13, wherein the open lower end of the inner portion further includes a chamfer-shaped edge.

15. The method of claim 13, wherein the open lower end of the outer portion further includes a chamfer-shaped edge.

16. The method of claim 13, wherein the inner portion further includes one or more holes disposed below the outer portion for insertion of one or more fasteners to selectably and securely engage the inner portion to the pole.

17. The method of claim 13, wherein the outer portion further includes one or more holes for insertion of one or more fasteners to selectably and securely engage the outer portion to a post.

18. The method of claim 17, wherein the post is a boat dock post.
